(19) United States
(12) Patent Application Publication
(10) Pub. No.: US 2016/0267624 A1
(43) Pub. Date: Sep. 15, 2016

(54) INFORMATION TERMINAL AND IMAGE DISPLAY SYSTEM

(71) Applicants: Kei OYAMADA, Kanagawa (JP); Aritaka HAGIWARA, Kanagawa (JP); Hidekuni ANNAKA, Saitama (JP)

(72) Inventors: Kei OYAMADA, Kanagawa (JP); Aritaka HAGIWARA, Kanagawa (JP); Hidekuni ANNAKA, Saitama (JP)

(73) Assignee: RICOH COMPANY, LTD., TOKYO (JP)

(21) Appl. No.: 15/003,911

(22) Filed: Jan. 22, 2016

(30) Foreign Application Priority Data
Mar. 11, 2015 (JP) 2015-048393

(51) Int. Cl. G06T 1/60; G06T 3/40; G09G 5/00

(52) U.S. Cl. CPC G06T 1/60; G09G 5/003; G06T 3/40; G09G 2370/02

(57) ABSTRACT

An information terminal includes a display unit configured to display, on a screen, a frame including an image output from an application; a storage unit configured to store compression ratio information defining a compression ratio corresponding to the application; a determining unit configured to determine the application that is displaying the image on the display unit; a generating unit configured to generate data by acquiring, from the compression ratio information, the compression ratio corresponding to the application determined by the determining unit, and compressing the frame by the acquired compression ratio; and a sending unit configured to send the data.

### BACKGROUND OF THE INVENTION

1. Field of the Invention

The present invention relates to an information terminal and an image display system.

2. Description of the Related Art

In conferences, etc., it is a general practice to connect an information terminal such as a PC (Personal Computer) and an image display apparatus such as a projector, and display the image data that is held in the information terminal, on the image display apparatus. Furthermore, there is already known a technology of connecting the information terminal and the image display apparatus via a network such as wired LAN (Local Area Network) or wireless LAN, etc., instead of making the connection by using a video transmission cable such as a RGB cable.

Furthermore, the information terminal that is connected to the image display apparatus does not directly output the image obtained by capturing the screen of the information terminal, but sends video data that has undergone a compression process, to the image display apparatus. Accordingly, the information terminal exhibits practical performance in a limited network band.

The compression ratio, which is used when the information terminal generates the data that has undergone the compression process, is preferably automatically set to an appropriate value, according to the type of application displaying the image on the screen of the information terminal.

However, a general-purpose information terminal such as a PC does not have a means for automatically identifying the application displaying the image on the screen of the information terminal.

Therefore, the user needs to determine the compression ratio by himself.

Patent Document 1: Japanese Laid-Open Patent Publication No. 2012-133586

### SUMMARY OF THE INVENTION

The present invention provides an information terminal and an image display system, in which one or more of the above-described disadvantages are eliminated.

According to an aspect of the present invention, there is provided an information terminal including a display unit configured to display, on a screen, a frame including an image output from an application; a storage unit configured to store compression ratio information defining a compression ratio corresponding to the application; a determining unit configured to determine the application that is displaying the image on the display unit; a generating unit configured to generate data by acquiring, from the compression ratio information, the compression ratio corresponding to the application determined by the determining unit, and compressing the frame by the acquired compression ratio; and a sending unit configured to send the data.

According to an aspect of the present invention, there is provided an image display system including an information terminal and an image display apparatus connected to the information terminal via a network, the image display system including a first display unit configured to display a frame including an image output from an application; a storage unit configured to store compression ratio information defining a compression ratio corresponding to the application; a determining unit configured to determine the application that is displaying the image on the first display unit; a generating unit configured to generate data by acquiring, from the compression ratio information, the compression ratio corresponding to the application determined by the determining unit, and compressing the frame by the acquired compression ratio; a sending unit configured to send the data; and a second display unit configured to display the data.

According to an aspect of the present invention, there is provided a non-transitory computer-readable recording medium storing a program that causes a computer that constitutes an information terminal to execute a process, the process including displaying, on a display unit, a frame including an image output from an application; storing, in a storage unit, compression ratio information defining a compression ratio corresponding to the application; determining the application that is displaying the image on the display unit; generating data by acquiring, from the compression ratio information, the compression ratio corresponding to the application determined at the determining, and compressing the frame by the acquired compression ratio; and sending the data.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a system configuration of an image display system according to an embodiment;

FIG. 2 illustrates an example of a hardware configuration of an information terminal according to an embodiment;

FIG. 3 illustrates an example of a hardware configuration of an image display apparatus according to an embodiment;

FIG. 4 illustrates an example of a software configuration of the information terminal according to an embodiment;

FIGS. 5A through 5D illustrate examples of various kinds of information;

FIG. 6 illustrates an example of a software configuration of the image display apparatus according to an embodiment;

FIG. 7 is a sequence diagram of an example of image transmission procedures according to an embodiment;

FIG. 8 is for describing the method of determining the resolution of the screen of the information terminal;

FIG. 9 is a sequence diagram of an example of image transmission procedures when changing the application according to an embodiment; and

FIG. 10 is a sequence diagram of an example of application detection procedures according to an embodiment.

### DETAILED DESCRIPTION OF THE PREFERRED EMBODIMENTS

A description is given, with reference to the accompanying drawings, of embodiments of the present invention. Note that the following embodiments are merely examples, and the embodiments to which the present invention is applied are not limited to the following.

### <Overview>

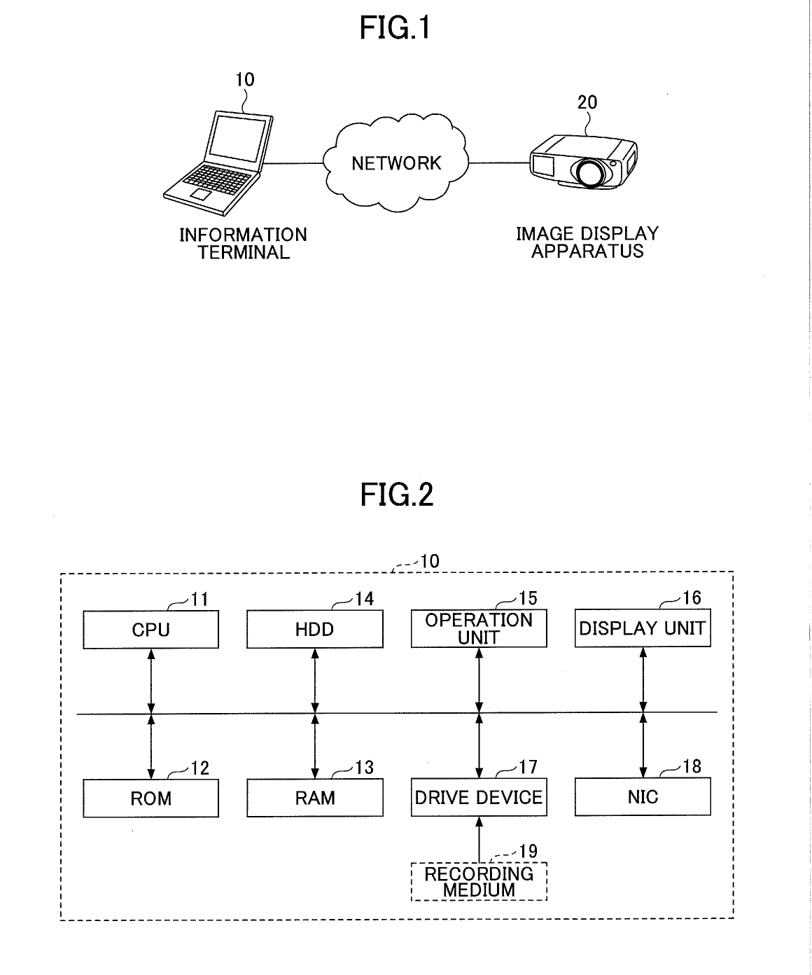

FIG. 1 illustrates an example of a system configuration of an image display system according to an embodiment. The image display system according to an embodiment includes an information terminal 10 and an image display apparatus 20, and the information terminal 10 and the image display apparatus 20 are connected via a network. FIG. 1 illustrates one of each of the information terminal 10 and the image display apparatus 20; however, the image display system according to an embodiment may include a plurality of information terminals 10 and a plurality of image display apparatuses 20.

The information terminal 10 is, for example, a PC, a smartphone, a tablet, etc. The image display apparatus 20 is, for example, a projector, a display, etc.

The information terminal 10 displays, on a screen, an image that is generated by one or more applications installed in the information terminal 10 itself, and also captures, at a predetermined rate, an image displayed on the screen. Furthermore, the information terminal 10 generates video data by compressing the captured image by a predetermined compression ratio, and sends the generated video data to the image display apparatus 20. Furthermore, the information terminal 10 holds information defining an appropriate compression ratio for each of the one or more applications installed in the information terminal 10 itself. Based on this information, the information terminal 10 compresses the image obtained by capturing the screen of the information terminal 10, by a compression ratio appropriate for the application displaying the image on the screen of the information terminal 10. The image display apparatus 20 decodes the video data received from the information terminal 10, and displays the decoded video data on the screen of the image display apparatus 20.

For example, video data, which is generated from an image of text data, generally has a characteristic that there are few changes in the image. Furthermore, in order to secure the viewability of the text data, a low compression ratio is preferably applied to each image. Therefore, in the case of an application for displaying text data, for example, the information terminal 10 automatically performs an operation of compressing the captured image by a low compression ratio.

Furthermore, video data, which is generated from a moving image, generally has a characteristic that there are many changes in the image. Furthermore, in the case of a moving image, smoothness is to be secured rather than viewability, and therefore the data amount of the video data is preferably small. Therefore, in the case of an application for displaying a moving image, for example, the information terminal 10 automatically performs an operation of compressing the captured image by a high compression ratio.

### <Hardware Configuration>

### (Information Terminal)

FIG. 2 illustrates an example of a hardware configuration of the information terminal 10 according to an embodiment. The information terminal 10 according to an embodiment includes a CPU 11, a ROM 12, a RAM 13, a HDD 14, an operation unit 15, a display unit 16, a drive device 17, and a NIC (Network Interface card) 18.

The CPU 11 is a processor for controlling the overall information terminal 10. The CPU 11 executes an operating system, applications, programs such as various services, etc., stored in the HDD 14, and realizes various functions of the information terminal 10. The ROM 12 stores various programs and data used by programs, etc. The RAM 13 is used as a storage area for loading programs, a work area for the loaded programs, etc. The HDD 14 stores various kinds of information, programs, etc.

The operation unit 15 is a hardware element for receiving an input operation from the user, and is, for example, a keyboard, a mouse, a touch panel, etc.

The display unit 16 is a hardware element for displaying information to the user, and is, for example, a monitor, a liquid crystal display, etc.

The drive device 17 reads a program from a recording medium 19 recording the program. The program read by the drive device 17 is installed in, for example, the HDD 14. The NIC 18 is a communication interface for connecting the information terminal 10 to a network and transmitting and receiving data.

Note that the recording medium 19 is a non-transitory recording medium. An example of a recording medium 19 is a magnetic recording medium, an optical disc, a magnetic optical recording medium, and a non-volatile memory.

### (Image Display Apparatus)

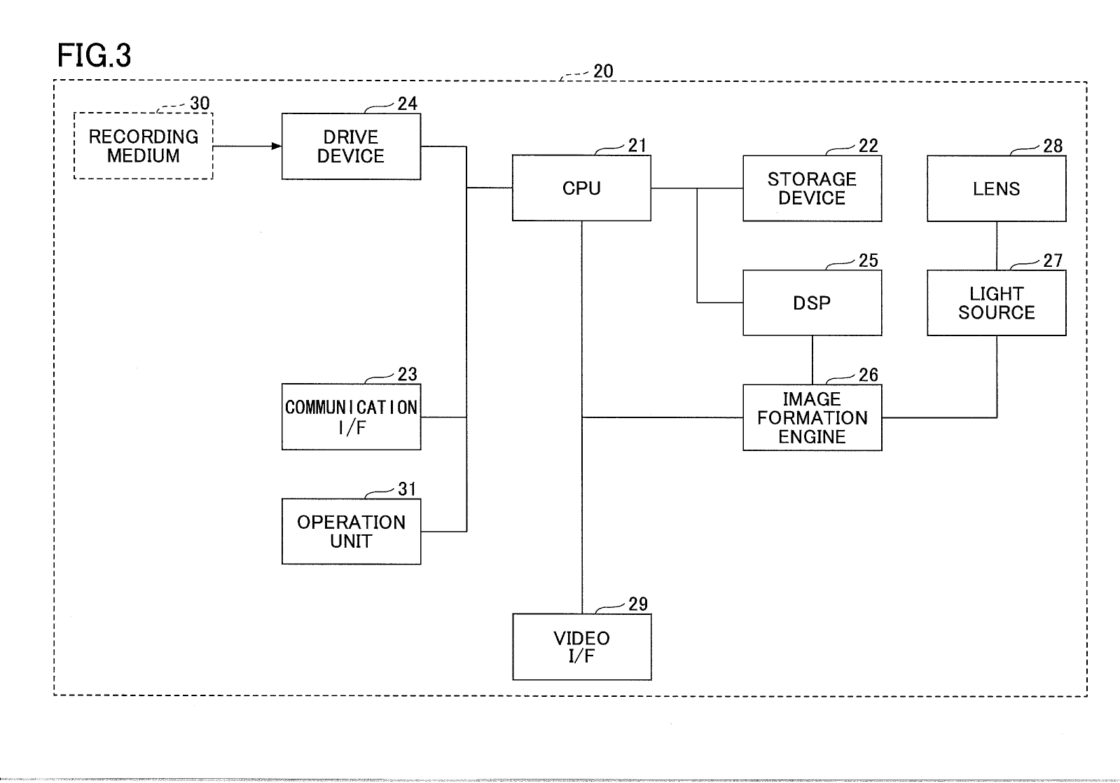

FIG. 3 illustrates an example of a hardware configuration of the image display apparatus 20 according to an embodiment. The image display apparatus 20 includes a CPU 21, a storage device 22, a communication I/F 23, a drive device 24, a DSP 25 (Digital Signal Processor), an image formation engine 26, a light source 27, a lens 28, a video I/F 29, and an operation unit 31. The image display apparatus 20 is, for example, a projector; however, the image display apparatus 20 may be a TV monitor, etc., provided with a display instead of the light source 27 and the lens 28.

The CPU 21 performs a process of transferring data, with the storage device 22, the communication I/F 23, the drive device 24, the DSP 25, the image formation engine 26, and the video I/F 29. Furthermore, the CPU 21 performs a process of comparing data, etc. The storage device 22 stores various programs, data used by the programs, and various kinds of setting information. The storage device 22 is used as a storage area for loading programs, a work area for the loaded programs, etc.

The communication I/F 23 is an interface connected to the network, and performs communication with the information terminal 10.

The drive device 24 reads a program from a recording medium 30 recording the program for implementing an embodiment. The program read by the drive device 24 is loaded in the storage device 22. Note that the recording medium 30 is a non-transitory recording medium 30. An example of a recording medium 30 is a magnetic recording medium, an optical disc, a magnetic optical recording medium, and a non-volatile memory.

The DSP 25 performs a digital signal process on the image displayed on a screen. The image formation engine 26 performs an image formation process based on the image that has undergone the digital signal process. The light source 27 and the lens 28 are for projecting the image that has undergone the image formation process, on a screen plane, etc.

The video I/F 29 is a HDMI (registered trademark) (High Definition Multimedia Interface) or an interface for inputting video signals, etc. The operation unit 31 is, for example, a keyboard or a mouse, and receives various kinds of input from the user.

### <Software Configuration>

### (Information Terminal)

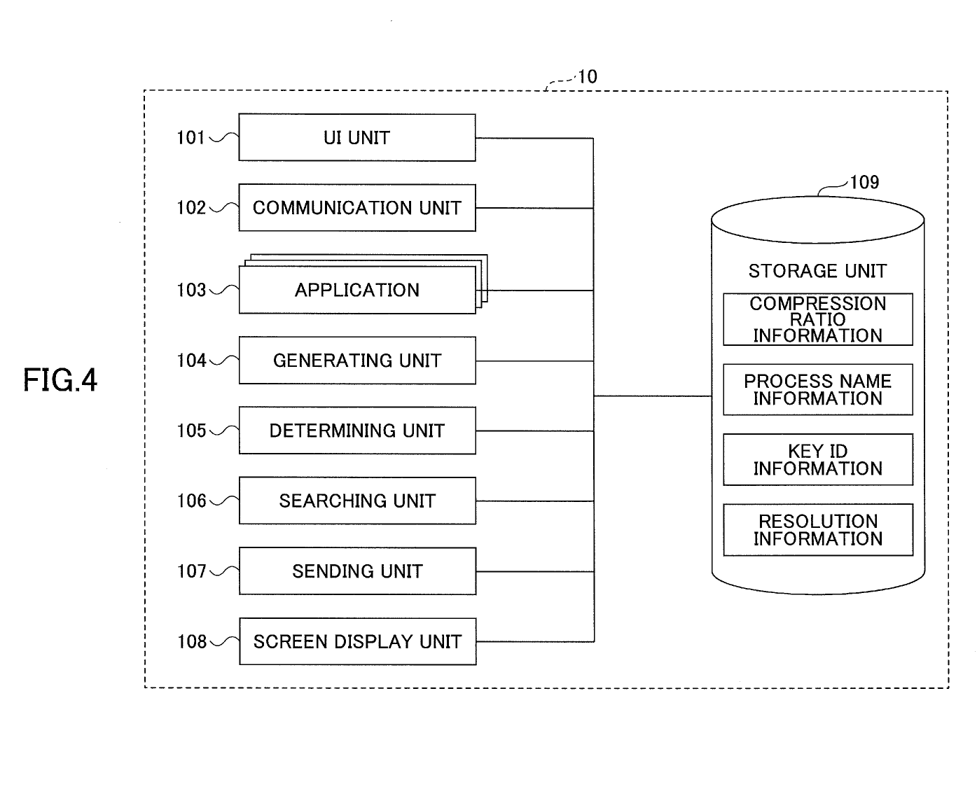

FIG. 4 illustrates an example of a software configuration of the information terminal 10 according to an embodiment. The information terminal 10 according to an embodiment includes a UI (User Interface) unit 101, a communication unit 102, applications 103, a generating unit 104, a determining unit 105, a searching unit 106, a transmission unit 107, a screen display unit 108, and a storage unit 109. These function units are realized by processes that the CPU 11 is caused to execute by one or more programs installed in the information terminal 10. The storage unit 109 may be realized by the ROM 12, the RAM 13, or a storage device connected to the information terminal 10 via the network.

The UI unit 101 displays a user interface screen on the operation unit 15 or the display unit 16, and also receives various operations from the user.

The communication unit 102 performs a process of transferring data with the image display apparatus 20 via the NIC 18.

The applications 103 include various applications installed in the information terminal 10, for example, a document creating application, a presentation application, an image editing application, etc. There is no limit to the number of applications 103 that are installable in the information terminal 10. Furthermore, the applications 103 may include any kind of application 103.

The generating unit 104 captures, at a predetermined rate, the entirety of or part of a screen displayed on the display unit 16, and performs a compression process (encoding process) on the captured image by a predetermined compression ratio acquired from the compression ratio information, to generate video data to be sent to the image display apparatus 20. Note that the generating unit 104 may generate the video data to be sent to the image display apparatus 20, by compressing an image acquired by another method, by a predetermined compression ratio. For example, the generating unit 104 may directly acquire an image from the application 103, and compress the acquired image by a predetermined compression ratio, to generate the video data to be sent to the image display apparatus 20.

The determining unit 105 determines which application 103 is generating the images displayed on the display unit 16, among the applications 103 installed in the information terminal 10.

The searching unit 106 searches the image display apparatus 20 connected to the network, and acquires connection information for connecting the image display apparatus 20 and the information terminal 10, from the image display apparatus 20.

The transmission unit 107 sends an image generated by the generating unit 104 to the image display apparatus 20, via the communication unit 102.

The screen display unit 108 displays, on the display unit 16, various images (text, images, moving images, etc.) generated by the applications 103.

The storage unit 109 stores compression ratio information, process name information, key ID information, and resolution information. The compression ratio information is information defining the compression ratio corresponding to each of the one or more applications. The process name information is information storing the process names of the one or more applications. The key ID information is information associating the application name of the application 103 that operates in combination with a hardware key such as a USB (Universal Serial Bus) dongle, with the ID (key ID) of the hardware key itself. The resolution information is information indicating the screen resolution required for each of the one or more applications 103 to display an image on the display unit 16.

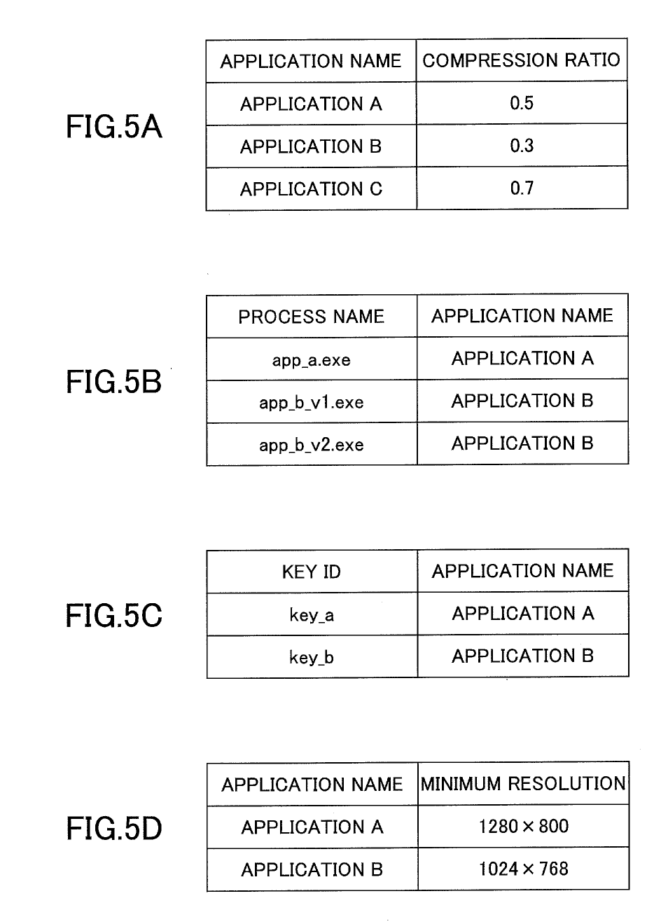

FIGS. 5A through 5D illustrate examples of various kinds of information. A description is given of a specific example of compression ratio information, process name information, key ID information, and resolution information, with reference to FIGS. 5A through 5D.

FIG. 5A illustrates an example of compression ratio information. The compression ratio information includes one or more records, and an application name and a compression ratio are stored in association with each other in each record. The application name is the name of the application 103, and the compression ratio indicates an appropriate compression ratio with respect to the image generated by the application 103. The example of FIG. 5A indicates that, when an image generated by application A is displayed on the display unit 16, it is preferable for the generating unit 104 to perform a compression process on the captured image by a compression ratio of 0.5. Similarly, the example of FIG. 5A indicates that, when an image generated by application B is displayed on the display unit 16, it is preferable for the generating unit 104 to perform a compression process on the captured image by a compression ratio of 0.3; and when an image generated by application C is displayed on the display unit 16, it is preferable for the generating unit 104 to perform a compression process on the captured image by a compression ratio of 0.7.

FIG. 5B illustrates an example of process name information. The process name information includes one or more records, and a process name and an application name are stored in association with each other in each record. A process name is a process name that is recognized on the OS, when the application 103 operates. The example of FIG. 5B indicates that the application name of the application having a process name “app_a.exe”, is application A. Similarly, the example of FIG. 5B indicates that the application having the process names “app_b_v1.exe” and “app_b_v2.exe” is application B. Note that the same application name is stored for different process names, because there are cases where a different process name is assigned according to a different version of the same application 103.

FIG. 5C illustrates an example of key ID information. The key ID information includes one or more records, and a key ID and an application name are stored in association with each other in each record. The example of FIG. 5C indicates that the application name of the application using a hardware key having a key ID “key_a” is application A. Similarly, the example of FIG. 5C indicates that the application name of the application using a hardware key having a key ID “key_b” is application B.

FIG. 5D illustrates an example of resolution information. The resolution information includes one or more records, and an application name and the minimum resolution are stored in association with each other in each record. The example of FIG. 5D indicates that the minimum resolution with respect to application A is “1280×800”. Similarly, the example of FIG. 5D indicates that the minimum resolution with respect to application B is “1024×768”. Note that the minimum resolution is the minimum screen resolution required for the operation of the application 103. When the setting of the screen resolution of the display unit 16 is less than or equal to the minimum resolution, there may be trouble in that the dialog of the application 103 does not fit in the screen. Therefore, when the information terminal 10 changes the screen resolution of the display unit 16, it is preferable that the screen resolution does not become lower than the minimum resolution stored in the resolution information.

### (Image Display Apparatus)

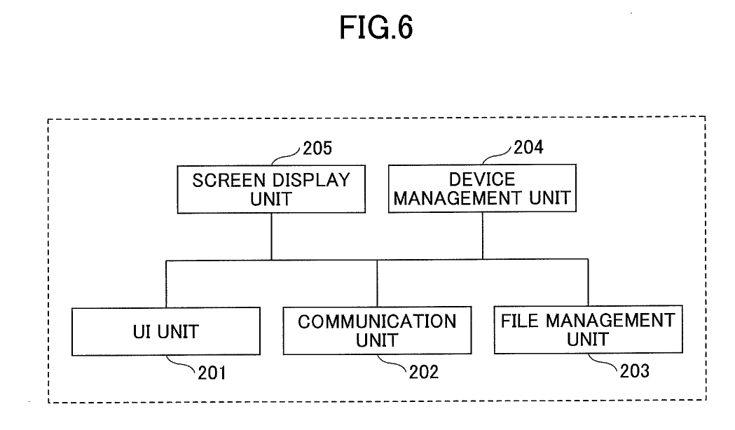

FIG. 6 illustrates an example of a software configuration of the image display apparatus 20 according to an embodiment. The image display apparatus 20 according to an embodiment includes a UI (User Interface) unit 201, a communication unit 202, a file management unit 203, a device management unit 204, and a screen display unit 205. These function units are realized by processes that the CPU 21 is caused to execute by one or more programs installed in the image display apparatus 20.

The UI unit 201 displays a user interface screen on the operation unit 31, and receives various operations from the user.

The communication unit 202 performs a process of transferring data with the information terminal 10 via the communication I/F 23. Furthermore, the communication unit 202 sends device information of the image display apparatus 20 itself stored in the device management unit 204, to the information terminal 10, upon receiving a request from the information terminal 10.

The file management unit 203 reads and writes files such as images stored in the recording medium 30.

The device management unit 204 manages device information and the device state of the image display apparatus 20, and various kinds of setting information necessary for the operation of the image display apparatus 20. In the device information of the image display apparatus 20, for example, the resolution of the screen projected on a screen plane by the screen display unit 205, etc., an IP address of the image display apparatus 20, etc., are stored.

The screen display unit 205 generates a still image or a moving image by decoding the video data received from the information terminal 10, and projects the generated image on a screen plane, etc., by using the image formation engine 26, the light source 27, and the lens 28.

### <Processing Procedures>

### (Transmission Procedures)

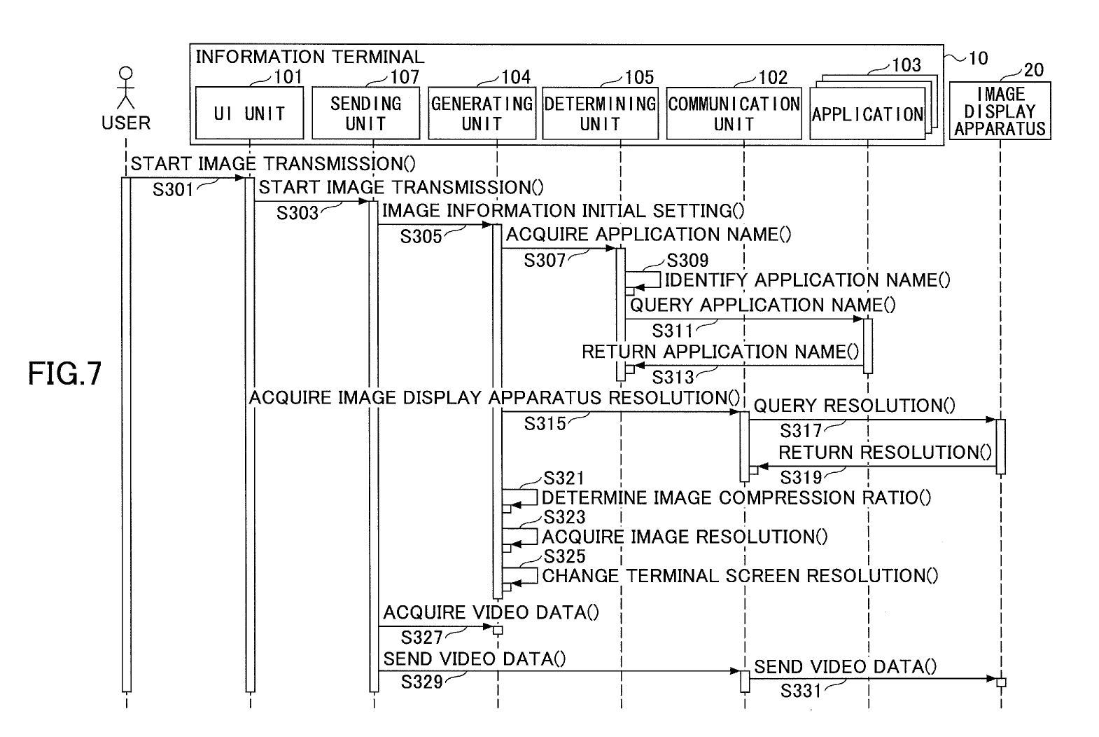

FIG. 7 is a sequence diagram of an example of transmission procedures according to an embodiment. With reference to FIG. 7, a description is given of processing procedures when video data is sent from the information terminal 10 to the image display apparatus 20, according to an instruction of the user.

In step S301, the user operates the UI unit 101 of the information terminal 10, and gives an instruction to display an image displayed on the display unit 16 of the information terminal 10, on the image display apparatus 20. Note that there may be cases where a plurality of image display apparatuses 20 are connected to the network, and therefore before the processing procedure of step S301, the information terminal 10 may prompt the user to select the image display apparatus 20 to which a connection is to be made. In this case, the searching unit 106 of the information terminal 10 may search for the image display apparatuses 20 connected to the network, and a list of the search-found image display apparatuses 20 may be displayed on the UI unit 101.

In step S303, the UI unit 101 sends an image transmission start signal to the transmission unit 107.

In step S305, the transmission unit 107 sends an image information initial setting signal to the generating unit 104, and gives an instruction to generate the video data to be sent to the image display apparatus 20.

In step S307, before starting to generate the video data to be sent to the image display apparatus 20, the generating unit 104 sends an application name acquiring signal to the determining unit 105.

In step S309, the determining unit 105 identifies the application name of the application 103 displaying the image on the display unit 16, in order to determine the application 103 that is displaying the image on the display unit 16.

For example, the determining unit 105 may identify a process name operating in the foreground based on the CPU usage ratios of the respective processes operating on the OS, and identify the application name corresponding to the identified process name by searching the process name information. Similarly, for example, the determining unit 105 may identify the process name operating in the foreground based on the temporal changes of the CPU usage ratios of the respective processes operating on the OS, or identify the process name operating in the foreground based on the memory usage amounts of the respective processes operating on the OS.

Furthermore, for example, the determining unit 105 may query the OS about the process name of the application 103 displaying an image on the display unit 16, and identify the application name corresponding to the process name returned in response to the query, by searching the process name information.

Furthermore, when the application 103 displaying an image on the display unit 16 is an application 103 that operates in combination with a hardware key such as a USB dongle connected to the drive device 17, etc., the determining unit 105 may query the OS about the key ID of the hardware key connected to the drive device 17, etc., and identify the application name corresponding to the key ID returned in response to the query, by searching the key ID information.

Furthermore, there may be cases where the application 103 installed in the information terminal 10 has an API (Application Programming Interface), etc., for querying the display unit 16 whether an image is being displayed, etc. In this case, the determining unit 105 may directly query the application 103, about the information as to whether the application 103 is displaying an image on the display unit 16 and the application name, by accessing the API by inter-process communication such as socket communication, etc. (steps S311, S313). Conversely, the determining unit 105 may identify (recognize) the application name, by directly receiving a report from the application 103 displaying an image on the display unit 16.

In step S315, the generating unit 104 sends a resolution acquiring signal to the communication unit 102, in order to acquire the screen resolution set in the image display apparatus 20.

In step S317, the communication unit 102 sends a resolution query signal to the image display apparatus 20.

In step S319, the image display apparatus 20 returns the screen resolution set in the image display apparatus 20 itself, to the information terminal 10.

In step S321, the generating unit 104 acquires the compression ratio corresponding to the application name identified by the processing procedure of step S309, by searching the compression ratio information, and determines the image compression ratio to be used when compressing the image obtained by capturing the image displayed on the display unit 16.

Note that when there are plurality of applications 103 displaying images on the display unit 16, the generating unit 104 may determine the compression ratio corresponding to the application name of the application 103 displaying the image at the forefront or the application name of the application 103 displaying the largest image, as the image compression ratio to be used when compressing the captured image. Furthermore, the generating unit 104 may acquire the compression ratios respectively corresponding to the plurality of applications 103 from the compression ratio information, and determine the average value of the compression ratios as the image compression ratio to be used when compressing the captured image. Furthermore, the priority level of each application may be included in the compression ratio information, and the generating unit 104 may determine the compression ratio corresponding to the application name having the highest priority level, as the image compression ratio to be used when compressing the captured image.

In step S323, the generating unit 104 acquires the minimum resolution corresponding to the application name identified by the processing procedure of step S309, by searching the resolution information.

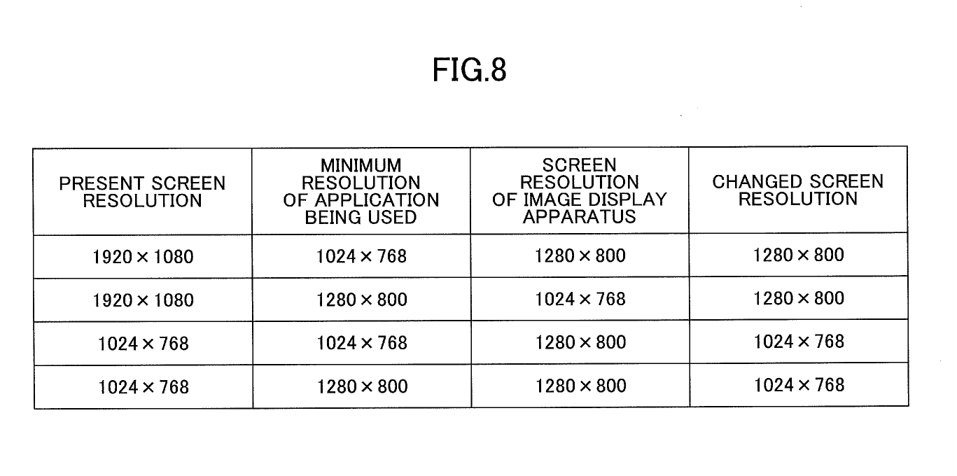

In step S325, the generating unit 104 determines the screen resolution to be applied to the display unit 16 of the information terminal 10, based on the minimum resolution acquired in step S323 and the screen resolution of the image display apparatus 20 acquired in step S319, and changes the screen resolution of the display unit 16 to the determined screen resolution. Here, with reference to FIG. 8, a description is given of a specific example of the processing procedure of step S325.

FIG. 8 is for describing the method of determining the resolution of the screen of the information terminal 10. In FIG. 8, the “present screen resolution” is the screen resolution presently being applied to the display unit 16. The “minimum resolution of application being used” is the minimum resolution acquired in step S323. The “screen resolution of the image display apparatus” is the screen resolution used for outputting an image by the image display apparatus 20, acquired in step S319.

For example, in a case where the “present screen resolution” is “1920×1080”, the “minimum resolution of application being used” is “1024×768”, and the “screen resolution of the image display apparatus” is “1280×800”, the screen resolution to be applied to the display unit 16 may be “1280×800”. By determining the screen resolution as described above, the generating unit 104 does not need to perform the process of changing the resolution of the captured image to match the screen resolution of the image display apparatus 20 (image reduction process), and therefore the processing load of the video data generating process (encoding process) can be reduced, and the performance of the information terminal 10 can be increased.

Furthermore, for example, in a case where the “present screen resolution” is “1920×1080”, the “minimum resolution of application being used” is “1280×800”, and the “screen resolution of the image display apparatus” is “1024×768”, the screen resolution to be applied to the display unit 16 may be “1280×800”. By determining the screen resolution as described above, it is possible to prevent problems that hinder the usage, such as a case where the dialog of the screen generated by the application 103 does not fit in the display unit 16.

Furthermore, for example, in a case where the “present screen resolution” is “1024×768”, the “minimum resolution of application being used” is “1024×768”, and the “screen resolution of the image display apparatus” is “1280×800”, the screen resolution to be applied to the display unit 16 may be “1024×768”. As described above, when the “present screen resolution” is lower than the “screen resolution of the image display apparatus” from the beginning, it is preferable not to change the screen resolution. For example, the user may be intentionally decreasing the screen resolution.

Furthermore, for example, in a case where the “present screen resolution” is “1024×768”, the “minimum resolution of application being used” is “1280×800”, and the “screen resolution of the image display apparatus” is “1280×800”, the resolution may be determined such that the screen resolution to be applied to the display unit 16 is “1024×768”. The user may be intentionally decreasing the screen resolution.

Note that in step S325, the generating unit 104 may determine the screen resolution to be applied to the display unit 16 of the information terminal 10, by using only the minimum resolution acquired in step S323. For example, the generating unit 104 may apply the minimum resolution acquired in step S323, to the display unit 16 of the information terminal 10. Furthermore, in step S325, the generating unit 104 may determine the screen resolution to be applied to the display unit 16 of the information terminal 10, by using only the screen resolution of the image display apparatus 20 acquired in step S319. For example, the generating unit 104 may apply the screen resolution of the image display apparatus 20 acquired in step S319, to the display unit 16 of the information terminal 10. Referring back to FIG. 7, the description is continued.

In step S327, the sending unit 107 sends a video data acquiring signal to the generating unit 104. The generating unit 104 captures images displayed on the display unit 16 at predetermined intervals, and performs a compression process (encoding process) on the captured images by the compression ratio determined in step S321 to generate video data to be sent to the image display apparatus 20, and sends the generated video data to the sending unit 107.

In steps S329 and S331, the sending unit 107 sends the video data to the image display apparatus 20 via the communication unit 102.

Note that instead of sending the video data from the information terminal 10 to the image display apparatus 20 according to an instruction by the user, the information terminal 10 may automatically start the processing procedures of step S305 through S331 of FIG. 7 at the timing when the information terminal 10 and the image display apparatus 20 are connected. That is, at the timing when the information terminal 10 and the image display apparatus 20 are connected, the information terminal 10 may perform the processes of identifying the application name, determining the image compression ratio, changing the screen resolution of the information terminal 10, etc. Accordingly, every time the information terminal 10 is connected to the image display apparatus 20, the information terminal 10 may determine the image compression ratio, etc., based on the latest usage status of the application 103 at the time point of the connection.

Note that in step S331, the information terminal 10 may send the video data to a device other than the image display apparatus 20. For example, the information terminal 10 may send (upload) the video data to a moving image management server, etc., on the Internet.

### (Application Changing Procedures)

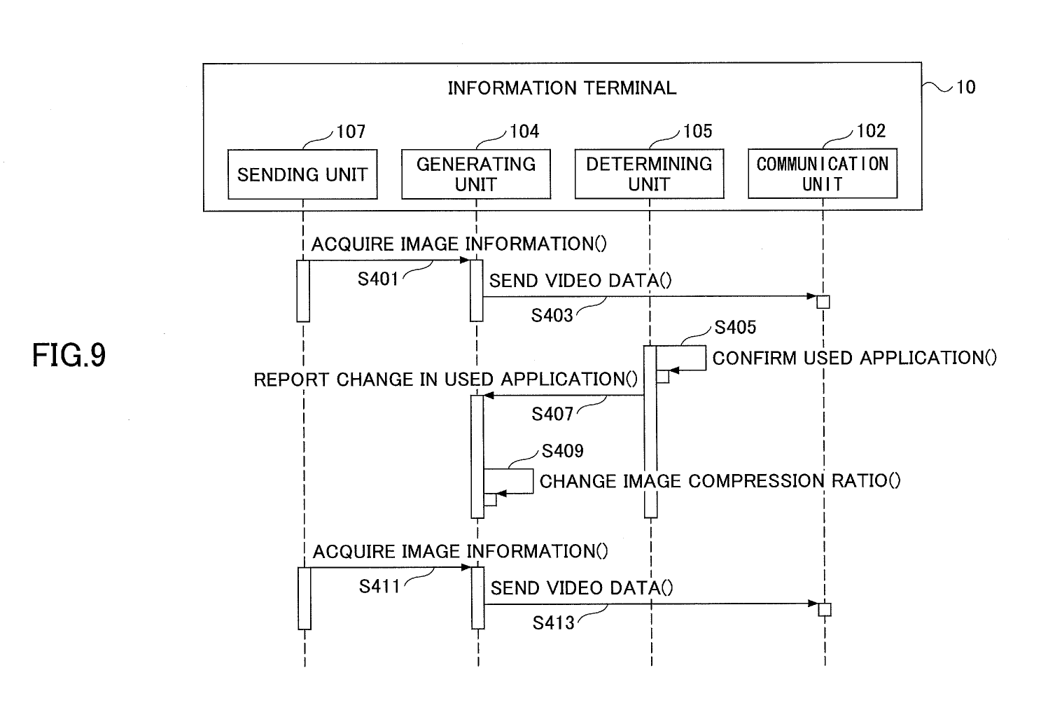

FIG. 9 is a sequence diagram of an example of processing procedures when changing the application according to an embodiment. With reference to FIG. 9, a description is given of processing procedures when the application 103 displaying an image on the display unit 16 of the information terminal 10 is changed, and the video data corresponding to the changed application 103 is sent to the image display apparatus 20.

Steps S401 and S403 are the same as steps S327 and S329 of FIG. 8, respectively, and therefore descriptions thereof are omitted. After step S403, the same processing procedure as that of step S331 of FIG. 8 is performed.

In step S405, while the video data is being sent to the image display apparatus 20, for example, the determining unit 105 performs the same processing procedures as those of steps S309 through S313 of FIG. 7 at predetermined intervals, to confirm whether the application name of the application 103 displaying the image on the display unit 16, is changed. The determining unit 105 may periodically confirm whether the application 103 is changed, or may confirm whether the application 103 is changed every time a movement of the mouse cursor is detected, etc. The determining unit 105 performs the processing procedure of step S407, when it is detected that the application 103 displaying an image on the display unit 16 is changed.

Note that the determining unit 105 may detect that the application 103 displaying an image on the display unit 16 is changed, by directly receiving a report from the application 103 displaying an image on the display unit 16, in step S405. This is because it is assumed that there may be cases where the application 103 installed in the information terminal 10 includes an API, etc., for reporting, to the determining unit 105, whether an image is displayed on the display unit 16.

In step S407, the determining unit 105 reports to the generating unit 104 that it is detected that the application 103, which is displaying an image on the display unit 16, is changed.

In step S409, for example, the generating unit 104 performs the same processing procedure as that of step S321 of FIG. 7, to determine an image compression ratio corresponding to the changed application name, and make a change such that the image is generated by the determined image compression ratio.

Steps S411 and S413 are the same as steps S327 and S329 of FIG. 8, respectively, and therefore descriptions thereof are omitted. After step S413, the same processing procedure as that of step S331 of FIG. 8 is performed.

Note that in FIG. 9, instead of the processing procedure of step S409, the processing procedures of steps S315 through S325 of FIG. 7 may be performed.

### (Application Detection Procedures)

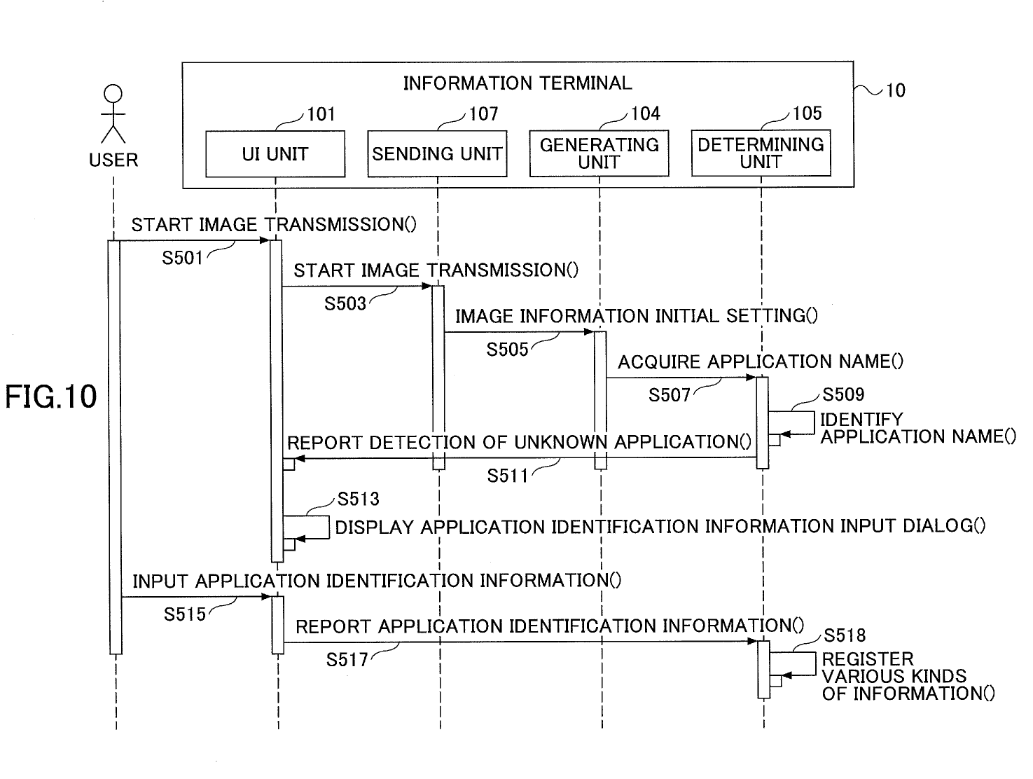

FIG. 10 is a sequence diagram of an example of application detection procedures according to an embodiment. With reference to FIG. 10, a description is given of processing procedures of a case where the application 103 displaying an image on the display unit 16 of the information terminal 10 cannot be recognized by the determining unit 105, and therefore the user is prompted to input the process name, the application name, and the compression ratio, and the UI unit 101 registers the input information in the process name information and the compression ratio information.

The processing procedures of steps S501 through S507 are the same as the processing procedures of steps S301 through S307 of FIG. 7, and therefore descriptions thereof are omitted.

In step S509, the determining unit 105 performs the processing procedure of step S309 of FIG. 7, to identify the application name displaying an image on the display unit 16. Here, it is assumed that the determining unit 105 is unable to identify the application name displaying an image on the display unit 16 (an unknown application 103 is detected).

In step S511, the determining unit 105 reports to the UI unit 101 that an unknown application 103 is detected.

In step S513, the UI unit 101 causes the operation unit 15 or the display unit 16 to display a dialog for the user to input information (process name, application name, and compression ratio) for identifying the application 103 displaying an image on the display unit 16 of the information terminal 10.

In step S515, the UI unit 101 receives input of information (process name, application name, and compression ratio) for identifying the application 103, from the user.

In step S517, the UI unit 101 reports, to the determining unit 105, the information (process name, application name, and compression ratio) for identifying the application 103, received from the user.

In step S519, the determining unit 105 registers the process name, the application name, and the compression ratio reported by the processing procedure of step S517, in the process name information and the compression ratio information, by adding new records.

### <Effects>

As described above, the image display system according to an embodiment determines the application 103 displaying an image on the screen of the information terminal 10, generates video data by performing a compression process by a compression ratio associated with the determined application 103, and sends the video data to the image display apparatus 20. Accordingly, the image display system according to an embodiment can automatically set an appropriate compression ratio according to the type of the application 103 displaying an image on the screen of the information terminal 10, and increase the convenience of the user.

Furthermore, the image display system according to an embodiment automatically changes the screen resolution set in the screen of the information terminal 10, based on the screen resolution set in the screen of the information terminal 10, the minimum resolution required for the application 103 displaying an image on the screen of the information terminal 10, and the screen resolution set in the image display apparatus 20. Accordingly, the image display system according to an embodiment is able to avoid the problem of capturing an image having an excessively large size, when the generating unit 104 captures the screen of the information terminal 10. Furthermore, accordingly, the image display system according to an embodiment can reduce the processing load in the video data generating process (encoding process), and increase the performance of the information terminal 10.

Furthermore, the image display system according to an embodiment confirms the application 103 displaying an image on the screen of the information terminal 10 at predetermined intervals. Accordingly, the image display system according to an embodiment can automatically set a more appropriate compression ratio in accordance with a change of the application 103, and increase the convenience of the user.

Furthermore, in the image display system according to an embodiment, when the application 103 displaying an image on the screen of the information terminal 10 cannot be identified (an unknown application 103 is detected), the user is prompted to input the process name, the application name, and the compression ratio of the application 103, and the input information is registered in the process name information and the compression ratio information by adding new records. Accordingly, the next time the same application 103 is activated, the image display system according to an embodiment can automatically identify the application 103.

### Supplement of Embodiments

In the embodiments described above, instead of the compression ratio information, information in which an application name and a value indicating the weight with respect to the compression ratio are stored in association with each other, may be held. Furthermore, the information terminal 10 may determine the type or the feature of the content being displayed on the screen, and dynamically determine the compression ratio based on the determination result, and further apply a weight corresponding to the application name, with respect to the determined compression ratio.

According to one embodiment of the present invention, a technology is provided for automatically setting the compression ratio used for generating video data to be output from an information terminal, according to the application to display the image on the screen of the information terminal.

The information terminal and the image display system are not limited to the specific embodiments described herein, and variations and modifications may be made without departing from the spirit and scope of the present invention.

The order of procedures in the sequences and flowcharts described in the embodiments may be replaced as long as there are no contradictions.

All of or part of the above embodiments may be implemented by a program. This program may be stored in a storage medium.

Note that in the embodiments, the screen display unit 108 is an example of a display unit. The storage unit 109 is an example of a storage unit. The determining unit 105 is an example of a determining unit. The generating unit 104 is an example of a generating unit. The generating unit 104 and the communication unit 102 are an example of an acquiring unit. The UI unit 101 is an example of an input unit. The video data is an example of data. The key ID information is an example of identifier information. The key ID is an example of an identifier of a hardware key. The entirety or part of the screen displayed on the display unit 16 is an example of a frame.

The present application is based on and claims the benefit of priority of Japanese Priority Patent Application No. 2015-048393, filed on Mar. 11, 2015, the entire contents of which are hereby incorporated herein by reference.

What is claimed is:

1. An information terminal comprising:
a display unit configured to display, on a screen, a frame including an image output from an application;
a storage unit configured to store compression ratio information defining a compression ratio corresponding to the application;
a determining unit configured to determine the application that is displaying the image on the display unit;
a generating unit configured to generate data by acquiring, from the compression ratio information, the compression ratio corresponding to the application determined by the determining unit, and compressing the frame by the acquired compression ratio; and
a sending unit configured to send the data.

2. The information terminal according to claim 1, wherein
the determining unit determines the application that is displaying the image on the display unit, based on a process name of the application.

3. The information terminal according to claim 1, wherein
the storage unit further stores identifier information associating an identifier of a hardware key, which is used for activating the application, with the application, and
the determining unit determines the application that is displaying the image on the display unit, based on the identifier information and the identifier of the hardware key that is acquired.

4. The information terminal according to claim 1, wherein
the determining unit determines the application that is displaying the image on the display unit, by querying the application as to whether the application is outputting the image on the display unit.

5. The information terminal according to claim 1, wherein
the determining unit determines the application that is displaying the image on the display unit, at predetermined intervals.

6. The information terminal according to claim 1, wherein
the determining unit determines the application that is displaying the image on the display unit, upon receiving a report from the application.

7. The information terminal according to claim 1, wherein
the storage unit further stores resolution information defining a resolution of the screen corresponding to the application, and
the display unit displays the screen by the resolution of the screen corresponding to the application that is displaying the image on the display unit, based on the resolution information.

8. The information terminal according to claim 1, wherein
the information terminal is connected to an image display apparatus via a network, and
the determining unit determines the application that is displaying the image on the display unit, when the information terminal and the image display apparatus are connected.

9. The information terminal according to claim 8, further comprising:
an acquiring unit configured acquire, from the image display apparatus, a screen resolution set in the image display apparatus, wherein
the display unit displays the screen based on the screen resolution set in the image display apparatus.

10. The information terminal according to claim 1, further comprising:
an input unit configured to receive input from a user, wherein
when the determining unit cannot determine the application that is displaying the image on the display unit, the determining unit prompts the user to input an image compression ratio corresponding to the application that is displaying the image on the display unit, and stores the input image compression ratio in the compression ratio information in association with the application.

11. An image display system including an information terminal and an image display apparatus connected to the information terminal via a network, the image display system comprising:
a first display unit configured to display a frame including an image output from an application;
a storage unit configured to store compression ratio information defining a compression ratio corresponding to the application;
a determining unit configured to determine the application that is displaying the image on the first display unit;
a generating unit configured to generate data by acquiring, from the compression ratio information, the compression ratio corresponding to the application determined by the determining unit, and compressing the frame by the acquired compression ratio;
a sending unit configured to send the data; and
a second display unit configured to display the data.

12. A non-transitory computer-readable recording medium storing a program that causes a computer that constitutes an information terminal to execute a process, the process comprising:
displaying, on a display unit, a frame including an image output from an application;
storing, in a storage unit, compression ratio information defining a compression ratio corresponding to the application;
determining the application that is displaying the image on the display unit;
generating data by acquiring, from the compression ratio information, the compression ratio corresponding to the application determined at the determining, and compressing the frame by the acquired compression ratio; and
sending the data.
